(19) United States
(12) Patent Application Publication
(10) Pub. No.: US 2016/0300169 A1
(43) Pub. Date: Oct. 13, 2016

(54) SUPPLY CHAIN NETWORK SENSITIVITY ANALYSIS USING ADJUSTED NETWORK PARAMETERS

(71) Applicant: Caterpillar Inc., Peoria, IL (US)

(72) Inventors: Anthony James GRICHNIK, Eureka, IL (US); Karunya JASTI, Peoria, IL (US)

(73) Assignee: Caterpillar Inc., Peoria, IL (US)

(21) Appl. No.: 14/684,269

(22) Filed: Apr. 10, 2015

(51) Int. Cl. G06Q 10/06; G06Q 10/08

(52) U.S. Cl. CPC G06Q 10/06312; G06Q 10/067; G06Q 10/0835

(57) ABSTRACT

A system is disclosed for adjusting network parameters for a network sensitivity analysis of a supply chain including a plurality of network entities. The system comprises a memory, one or more input/output devices, and a processor. The processor is configured to generate a supply chain network model and determine entity demands and a total network demand for the item. The processor is further configured to determine a total network demand change and iteratively assign a portion of the total network demand change to at least one network entity until all of the total network demand change is assigned. The processor is further configured to adjust the entity demand at the at least one network entity, modify the supply chain network model, analyze sensitivity of the supply chain network model, and configure the supply chain based on the analysis.

### TECHNICAL FIELD

This disclosure relates generally to supply chain network optimization, and more particularly, to a system and method for adjusting network parameters for a supply chain network sensitivity analysis.

### BACKGROUND

Supply chain planning may be essential to the success of many of today's companies. Most companies may rely on supply chain planning to ensure the timely and reliable delivery of products in response to customer demands. In supply chain network planning and sensitivity analysis, network parameters, such as the customer demands, are usually adjusted or varied to study the response of the supply chain network and the interactions of different components of the supply chain network. Such study is important to develop a robust, responsive supply chain.

For example, U.S. Pat. No. 7,480,623B1, to Landvater (“the '623 patent”) discloses a time-phased forecasting and replenishment system for retail organizations. The system calculates projected sales for each product at each facility and calculates projected replenishment shipments between facilities and suppliers. The calculated forecasts and replenishments are done in ways that account for the needs of retail organizations by considering, for example, holiday sales from prior years.

Conventional supply chain network planning techniques only consider the demand data at a single store or facility, but fail to simultaneously model the demand changes within the entire supply chain network. Furthermore, conventional supply chain planning techniques do not provide the capability to study and determine sensitivity of a supply chain in response to changes in network parameters of the supply chain. Thus, there is a need to allow convenient adjustments of network parameters so as to study the sensitivity of the supply chain and provide a more accurate and stable model for the supply chain.

The disclosed system and method are directed to improving upon existing technologies used in supply chain network sensitivity analysis.

### SUMMARY

In one aspect, the present disclosure is directed to a computer-implemented method for configuring, using a processor, a supply chain used to produce and deliver tangible goods based on a network sensitivity analysis. The supply chain includes a plurality of network entities. The method comprises generating, by the processor, a supply chain network model for the supply chain and determining, by the processor based on the supply chain network model, entity demands for an item at a plurality of network entities and a total network demand for the item. The method further comprises determining, by the processor, a percentage change in the total network demand and selecting, by the processor, one of the network entities. The method further comprises determining, by the processor, an entity demand change for the selected network entity based on the percentage change in the total network demand and the entity demand at the selected network entity and adjusting, by the processor, the entity demand at the selected network entity by the entity demand change. The method further comprises modifying, by the processor, the supply chain network model using the adjusted entity demand at the selected network entity, comparing, by the processor, the supply chain network model and the modified supply chain network model, analyzing, by the processor, sensitivity of the supply chain network model based on the comparison, and configuring the supply chain according to the sensitivity analysis of the supply chain network model.

In another aspect, the present disclosure is directed to a computer-implemented method for configuring, using a processor, a supply chain used to produce and deliver tangible goods based on a network sensitivity analysis. The supply chain includes a plurality of network entities. The method comprises generating, by the processor, a supply chain network model for the supply chain and determining, by the processor based on the supply chain network model, entity demands for an item at the plurality of network entities and a total network demand for the item. The method further comprises determining, by the processor, a total network demand change based on a percentage change in the total network demand and iteratively assigning, by the processor, a portion of the total network demand change to at least one of the plurality of network entities until all of the total network demand change is assigned. The method further comprises adjusting, by the processor, the entity demand at the at least one of the plurality of network entities by the assigned portion of the total network demand change, modifying, by the processor, the supply chain network model using the adjusted entity demand at the at least one of the plurality of network entities, analyzing, by the processor, sensitivity of the supply chain network model based on the modified supply chain network model, and configuring the supply chain according to the sensitivity analysis of the supply chain network model.

In another aspect, the present disclosure is directed to a system for configuring a supply chain used to produce and deliver tangible goods based on a network sensitivity analysis. The supply chain includes a plurality of network entities. The system comprises a memory configured to store instructions, one or more input/output devices configured to receive user inputs and generate a user interface, and a processor configured to receive the instructions from the memory and execute the instructions. The instructions cause the processor to, generate a supply chain network model for the supply chain and determine, based on the supply chain network model, entity demands for an item at the plurality of network entities and a total network demand for the item. The instructions further cause the processor to determine a total network demand change based on a percentage change in the total network demand and iteratively assign a portion of the total network demand change to at least one of the plurality of network entities until all of the total network demand change is assigned. The instructions further cause the processor to adjust the entity demand at the at least one of the plurality of network entities by the assigned portion of the total network demand change, modify the supply chain network model using the adjusted entity demand at the at least one of the plurality of network entities, analyze sensitivity of the supply chain network model based on the modified supply chain network model, and configure the supply chain according to the sensitivity analysis of the supply chain network model.

In yet another aspect, the present disclosure is directed to a non-transitory computer-readable medium including instructions, which, when executed by a processor, cause the processor to perform a method for configuring a supply chain used to produce and deliver tangible goods based on a network sensitivity analysis. The supply chain includes a plurality of network entities. The method performed by the processor comprises generating a supply chain network model for the supply chain and determining, based on the supply chain network model, entity demands for an item at the plurality of network entities and a total network demand for the item. The method further comprises determining a total network demand change based on a percentage change in the total network demand and iteratively assigning a portion of the total network demand change to at least one of the plurality of network entities until all of the total network demand change is assigned. The method further comprises adjusting the entity demand at the at least one of the plurality of network entities by the assigned portion of the total network demand change, modifying the supply chain network model using the adjusted entity demand at the at least one of the plurality of network entities, analyzing sensitivity of the supply chain network model based on the modified supply chain network model, and configuring the supply chain according to the sensitivity analysis of the supply chain network model.

### BRIEF DESCRIPTION OF THE DRAWINGS

FIG. 1 is a schematic illustration of an exemplary supply chain in which the supply chain sensitivity analysis system consistent with the disclosed embodiments may be implemented.

FIG. 2 is a schematic illustration of an exemplary supply chain sensitivity analysis system consistent with certain disclosed embodiments.

FIG. 3A is a flow chart illustrating an exemplary process for supply chain sensitivity analysis, consistent with a disclosed embodiment.

FIG. 3B is a flow chart illustrating an exemplary process for adjusting network parameters for supply chain sensitivity analysis, consistent with a disclosed embodiment.

FIG. 3C is a flow chart illustrating another exemplary process for adjusting network parameters for supply chain sensitivity analysis, consistent with a disclosed embodiment.

FIG. 4 illustrates an exemplary supply chain network model for the supply chain shown in FIG. 1, consistent with a disclosed embodiment.

FIG. 5 illustrates an exemplary optimized supply chain network model for the supply chain shown in FIG. 1, consistent with a disclosed embodiment.

FIG. 6 illustrates an exemplary optimized supply chain network model for the supply chain shown in FIG. 1, consistent with another disclosed embodiment.

### DETAILED DESCRIPTION

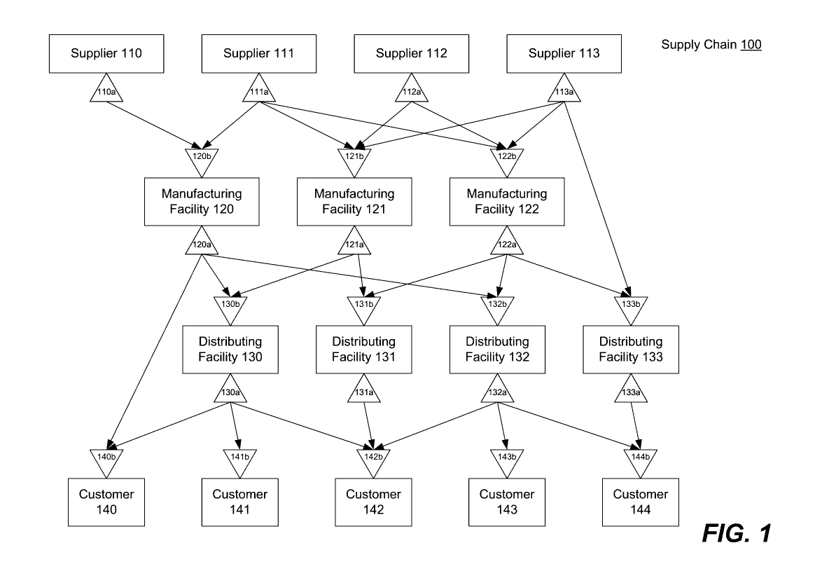

FIG. 1 illustrates an exemplary supply chain 100 in which a supply chain sensitivity analysis system consistent with the disclosed embodiments may be implemented. As shown in FIG. 1, supply chain 100 may include a plurality of supply chain entities, such as suppliers 110-113, manufacturing facilities 120-122, distributing facilities 130-133, and customers 140-144. Supply chain 100 may be used to supply individual items to suppliers 110-113, manufacturing facilities 120-122, distributing facilities 130-133, or customers 140-144. An item, as used herein, may represent any type of physical good that is designed, developed, manufactured, and/or delivered by supply chain 100. Non-limiting examples of the items may include engines, tires, wheels, transmissions, pistons, rods, shafts, or any other suitable component of a product. Alternatively, the term “item” here may also refer to a finished product delivered to a customer. A product, as used herein, may represent any type of finished good that is manufactured, assembled, and delivered to the customers of supply chain 100. Non-limiting examples of products may include chemical products, mechanical products, pharmaceutical products, food, and fixed or mobile machines such as trucks, cranes, earth moving vehicles, mining vehicles, backhoes, material handling equipment, farming equipment, marine vessels, on-highway vehicles, or any other type of machine that operates in a work environment.

Suppliers 110-113 may supply individual items to one or more of manufacturing facilities 120-122, one or more of distributing facilities 130-133, and one or more of customers 140-144. Manufacturing facilities 120-122 may manufacture or assemble products by using one or more individual items received from suppliers 110-113. The product may include one or more components supplied from suppliers 110-113. The products manufactured by different manufacturing facilities 120-122 may be identical, or may be different from each other. Manufacturing facilities 120-122 may respectively deliver the manufactured products to one or more distributing facilities 130-133, or directly to one or more customers 140-144.

Distributing facilities 130-133 may store individual items received from one or more suppliers 110-113, and may distribute the individual items to customers 140-144 for sale as service or replacement parts for existing products. In addition, distributing facilities 130-133 may store manufactured products received from one or more manufacturing facilities 120-122, and may distribute the manufactured products to customers 140-144. In some embodiments, one of distributing facilities 130-133 may distribute the individual items or manufactured products to another one of distributing facilities 130-133, before the individual items or manufactured products are finally distributed to customers 140-144.

Although supply chain 100 shown in FIG. 1 includes four suppliers 110-113, three manufacturing facilities 120-122, four distributing facilities 130-133, and five customers 140-144, those skilled in the art will appreciate that supply chain 100 may include any number of suppliers, manufacturing facilities, distributing facilities, and dealers.

The supply chain entities in supply chain 100 may include upstream supply chain entities, such as suppliers 110-113, and downstream supply chain entities, such customers 140-144. In supply chain 100, items may flow in a direction from upstream supply chain entities to downstream supply chain entities. Inside each supply chain entity, at least one of a downstream inventory and an upstream inventory may be included. Downstream inventory 110a-113a, 120a-122a, 130a-133a may include inventories of items (e.g., products, parts, or subsystems) that a supply chain entity may need to keep before the items may be accepted by the supply chain entity's downstream supply chain entities. For example, manufacturing facility 120 may include a downstream inventory 120a of products before the items can be transported to and accepted by distributing facility 130.

On the other hand, upstream inventory 120b-122b, 130b-133b, and 140b-144b may include inventories of items (products, parts, or subsystems) that a supply chain entity receives from the supply chain entity's upstream supply chain entities and may need to keep before the items may be used in manufacturing or other transactional processes. In the same example above, manufacturing facility 120 may also include an upstream inventory 120b of engines from supplier 110 before the work machines may be manufactured using the engines and other parts or subsystems. Further, similar to manufacturing facility 120, suppliers 110-113 may respectively include downstream inventories 110a-113a, 120a-122a, 130a-133a; manufacturing facilities 121 and 122 may respectively include downstream inventories 121a and 122a and upstream inventories 121b and 122b; distributing facilities 130-133 may respectively include downstream inventories 130a-133a and upstream inventories 130b-133b; and customers 140-144 may respectively include upstream inventories 140b-144b.

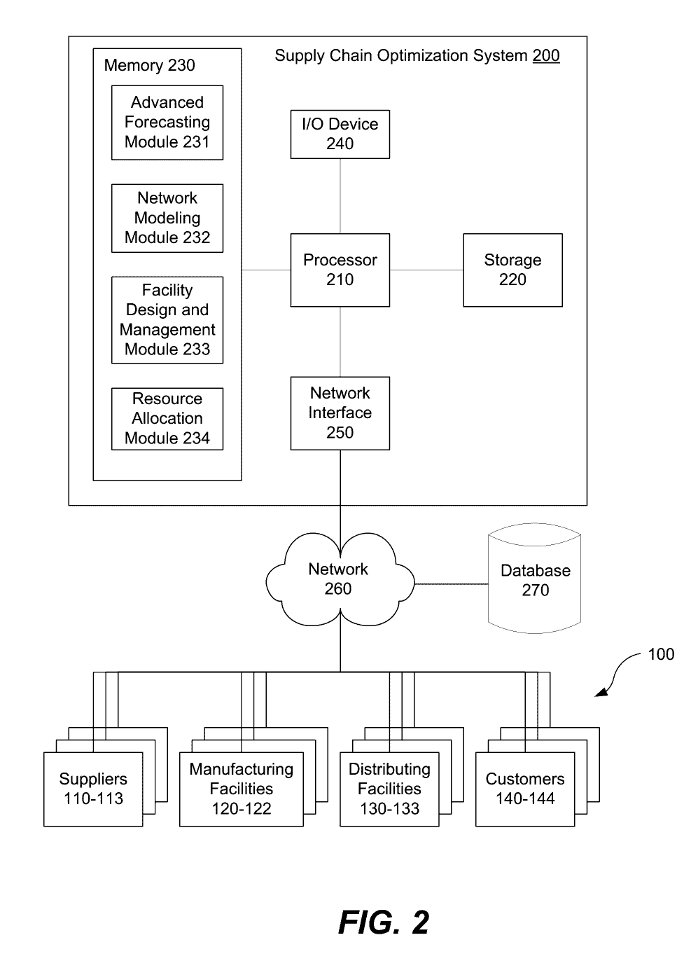

When customers 140-144 make demands to manufacturing facilities 120-122 or distributing facilities 130-133, the structure of the distribution network may be designed to fulfill the demands. The design of the distribution network may be determined according to a plurality of objectives including, for example, minimum inventory cost, maximum profit of the business, time required to fulfill the demands, environmental impact, resilience of the network, total route distance, etc. The determination may be carried out according to disclosed embodiments by an exemplary system as shown in FIG. 2. The system disclosed herein may consider one or more of these objectives simultaneously in determining the structure of the distribution network. The system may use any linear or nonlinear programming techniques known in the art to determine a model or design for supply chain 100 according to the objectives. In some embodiments, the objectives considered by the system may be competing with one another. The system may balance the competing objectives while determining the model for supply chain 100.

It is further noted that each arrowed line in FIG. 1 directing from an upstream entity to a downstream entity represents a transportation path between the associated upstream entity and the associated downstream entity. Each transportation path may be supported by one or more of automobiles, vessels, or planes via land, water, or air. Furthermore, each arrowed line indicates that the associated upstream entity has the capability to deliver items or products to the associated downstream entity. In a particular implementation of supply chain 100, however, a transportation path represented by a given arrowed line may not be used or assigned to actually transport any items. Accordingly, for a set of objectives, supply chain 100 may use all or part of the available transportation paths to deliver the items and products.

FIG. 2 illustrates an exemplary supply chain optimization system 200 (hereinafter referred to as “system 200”) consistent with certain disclosed embodiments. As shown in FIG. 2, system 200 may include one or more hardware and/or software components configured to display, collect, store, analyze, evaluate, distribute, report, process, record, and/or sort information related to logistics network management. System 200 may include one or more of a processor 210, a storage 220, a memory 230, an input/output (I/O) device 240, and a network interface 250. System 200 may be connected via network 260 to database 270 and supply chain 100, which may include one or more of supply chain entities, such as suppliers 110-113, manufacturing facilities 120-122, distributing facilities 130-133, and customers 140-144. That is, system 200 may be connected to computers or databases stored at one or more of the supply chain entities.

System 200 may be a server, client, mainframe, desktop, laptop, network computer, workstation, personal digital assistant (PDA), tablet PC, scanner, telephony device, pager, and the like. In one embodiment, system 200 may be a computer configured to receive and process information associated with different supply chain entities involved in supply chain 100, the information including purchasing orders, inventory data, and the like. In addition, one or more constituent components of system 200 may be co-located with any one of the supply chain entities.

Processor 210 may include one or more processing devices, such as one or more microprocessors from the Pentium™ or Xeon™ family manufactured by Intel™, the Turion™ family manufactured by AMD™, or any other type of processors. As shown in FIG. 2, processor 210 may be communicatively coupled to storage 220, memory 230, I/O device 240, and network interface 250. Processor 210 may be configured to execute computer program instructions to perform various processes and methods consistent with certain disclosed embodiments. In one exemplary embodiment, computer program instructions may be loaded into memory 230 for execution by processor 210.

Storage 220 may include a volatile or non-volatile, magnetic, semiconductor, tape, optical, removable, nonremovable, or other type of storage device or computer-readable medium. Storage 220 may store programs and/or other information that may be used by system 200.

Memory 230 may include one or more storage devices configured to store information used by system 200 to perform certain functions related to the disclosed embodiments. In one embodiment, memory 230 may include one or more modules (e.g., collections of one or more programs or subprograms) loaded from storage 220 or elsewhere that perform (i.e., that when executed by processor 210, enable processor 210 to perform) various procedures, operations, or processes consistent with the disclosed embodiment. For example, memory 230 may include an advanced forecasting module 231, a network modeling module 232, a facility design and management module 233, and a resource allocation module 234.

Advanced forecasting module 231 may generate forecast information related to one or more items at any one of the supply chain entities based on historical data associated with the item. For example, advanced forecasting module 231 may forecast or estimate a future demand for an item at each one of manufacturing facilities 120-122 and distributing facilities 130-133 based on respective historical demand data for that item at manufacturing facilities 120-122 and distributing facilities 130-133. Advanced forecasting module 231 may forecast or estimate future demands for an item at suppliers 110-113 by combining the forecasted demands for the item at each one of manufacturing facilities 120-122 and distributing facilities 130-133.

In addition, advanced forecasting module 231 may forecast or estimate the demand for a given item (e.g., a product) at each one of customers 140-144. Advanced forecasting module 231 may use a range of information to forecast or estimate the demands for the products, such as historical demand data at each customer, seasonal variations associated with a time period and the location of the customer, recent political or social events at the location of the customer, etc. Advanced forecasting module 231 may further determine a total network demand for the products based on the estimated demands at customers 140-144.

Network modeling module 232 may receive the forecasted information (e.g., the demands for an item) from advanced forecasting module 231 and simulate and optimize the flow of materials, parts, components, etc., between the supply chain entities and the structure of the supply chain network in order to meet certain business goals or objectives of the entire organization. The business goals or objectives may include at least one of response time, costs, profit, return on net assets, inventory turns, inventory level, service level, resilience of the supply chain network, environmental impact, total route distance, etc. Network modeling module 232 may simulate the flow of materials, parts, or components and optimize the structure of the supply chain network based on a number of parameters, such as geographical locations of each one of the supply chain entities, the transportation methods (e.g., air, ship, truck, etc.), the capacities of the transportation links (e.g., quantity of materials that can be transported via a certain route), and the manufacturing capacities of the manufacturing facilities. Based on the simulation results and other information such as production costs, transportation costs, and regional sales prices, and the like, network modeling module 232 may generate information such as gross revenue, cost of goods sold, and profit related to one or more products or parts.

Network modeling module 232 may further generate an optimized network structure of the supply chain based on the parameters and information discussed above. The optimized network structure of the supply chain may specify, for example, the links or paths (i.e., represented by the arrowed line of FIG. 1) among the entities used to fill the demand for the item, the transportation methods used to transport materials and goods from one entity to another, the inventory level that should be maintained at each entity, etc.

Facility design and management module 233 may receive the forecasted information from advanced forecasting module 231 and the simulation results from network modeling module 232 and may determine the physical structure and dimension of one or more of manufacturing facilities 120-122 and distributing facilities 130-133 based on the received information. For example, facility design and management module 233 may receive forecasted information representing a quantity of the incoming items to be received at manufacturing facilities 120-122 and distributing facilities 130-133. Based on this forecasted information, facility design and management module 233 may determine dimensions and locations of shelving, racks, aisles, and the like, of manufacturing facilities 120-122 and distributing facilities 130-133. Facility design and management module 233 may also determine the location of incoming items within manufacturing facilities 120-122 and distributing facilities 130-133, based on the forecasted information. Moreover, facility design and management module 233 may simulate the movement of resources (e.g., workers, machines, transportation vehicles, etc.) throughout manufacturing facilities 120-122 and distributing facilities 130-133 over time. Still further, facility design and management module 233 may modify input information in order to achieve one or more of the desired business goals.

Resource allocation module 234 may receive availability data representing the quantity of one or more items that are available at suppliers 110-113. When the availability data is less than the forecasted demand data of the item at suppliers 110-113, resource allocation module 234 may allocate the available items at manufacturing facilities 120-122, distributing facilities 130-133, and customers 140-144 in order to achieve one or more of the business goals associated with the entire organization.

I/O device 240 may include one or more components configured to communicate information associated with system 200. For example, I/O device 240 may include a console with an integrated keyboard and mouse to allow a user to input parameters associated with system 200 and/or data associated with supply chain 100. I/O device 240 may include one or more display devices, such as monitors, or other peripheral devices, such as printers, cameras, microphones, speaker systems, electronic tablets, bar code readers, scanners, or any other suitable type of I/O device 240. System 200 may generate user interfaces through the display devices to provide optimization results to users. The user interfaces may include graphical elements and text that represent various aspects of the optimization results. System 200 may provide guidance, through the user interfaces, to assist the users to analyze and operate supply chain 100.

Network interface 250 may include one or more components configured to transmit and receive data via network 260, such as, for example, one or more modulators, demodulators, multiplexers, de-multiplexers, network communication devices, wireless devices, antennas, modems, and any other type of device configured to enable data communication via any suitable communication network. Network interface 250 may also be configured to provide remote connectivity between processor 210, storage 220, memory 230, I/O device 240, and/or database 270, to collect, analyze, and distribute data or information associated with supply chain 100 and supply chain optimization.

Network 260 may be any appropriate network allowing communication between or among one or more computing systems, such as, for example, the Internet, a local area network, a wide area network, a Wi-Fi network, a workstation peer-to-peer network, a direct link network, a wireless network, or any other suitable communication network. Connection with network 260 may be wired, wireless, or any combination thereof.

Database 270 may be one or more software and/or hardware components that store, organize, sort, filter, and/or arrange data used by system 200 and/or processor 210. Database 270 may store one or more tables, lists, or other data structures containing data associated with logistics network management. For example, database 270 may store operational data associated with each one of the supply chain entities, such as inbound and outbound orders, production schedules, production costs, and resources. The data stored in database 270 may be used by processor 210 to receive, categorize, prioritize, save, send, or otherwise manage data associated with logistics network management.

### INDUSTRIAL APPLICABILITY

The disclosed supply chain optimization system 200 may efficiently provide optimized supply chain network designs for any business organization to achieve one or more desired business goals or objectives. Based on the disclosed system and methods, effects of variable network parameters may be analyzed, and the robustness, efficiency, accuracy, and sensitivity of the supply chain network designs may be significantly improved.

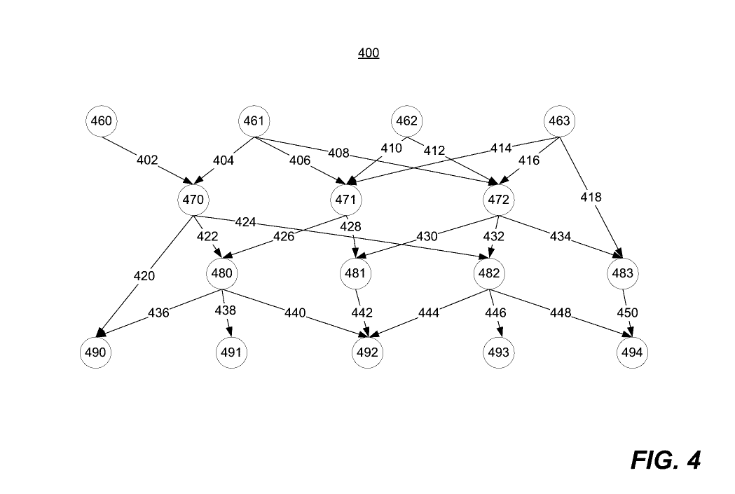

FIG. 4 depicts an exemplary supply chain network model 400 that system 200 generates for supply chain 100. Supply chain network model 400 includes a plurality of nodes 460-463 representing the supply chain entities, such as suppliers 110-113. Supply chain network model 400 further includes a plurality of nodes 470-472 representing manufacturing facilities 120-122. Supply chain network model 400 further includes a plurality of nodes 480-483 representing distributing facilities 130-133. And supply chain network model 400 further includes a plurality of nodes 490-494 representing customers 140-144. Each node may have properties attached thereto to represent, for example, inventory volume, inventory cost, manufacturing capacity, or demands of the corresponding supply chain entity.

In addition, supply chain network model 400 may include a plurality of edges 402-450 corresponding to the arrowed lines connecting the supply chain entities of FIG. 1. The edges may represent, for example, flow of components, materials, or parts from one supply chain entity to another. Each edge includes an arrow indicating a direction of the flow. Each customer node is connected with at least one supply node by a plurality of edges that form one or more routes. For example, customer node 490 is connected with supply node 460 by edges 402 and 420 that form a first route. Customer node 490 is also connected with supply node 460 by edges 402, 422, and 436 that form a second route.

Each edge in supply chain network model 400 includes one or more properties, such as transportation volume, transportation time, transportation cost, tariff, energy price, environmental impact (e.g., carbon monoxide or other airborne emission), available capacity to move goods, etc. Each property of an edge may be assigned a numerical value, which may be adjusted to optimize the supply chain model to achieve one or more given objectives.

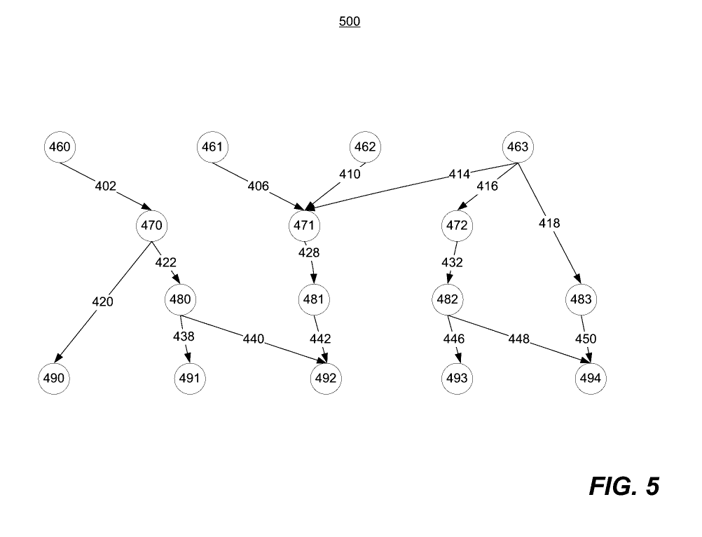

In an exemplary embodiment, system 200 may generate an optimized network structure or design for supply chain 100 using supply chain network model 400. System 200 may use any known techniques, such as the ant colony method, the search tree method, or other linear or nonlinear optimization methods, to optimize the network structure for supply chain 100. FIG. 5 illustrates an exemplary optimized network structure 500 generated by system 200 for supply chain 100. Optimized network structure 500 may include only a portion of the edges indicating the transportation paths that will actually be used by supply chain 100 in the optimized implementation. The edges corresponding to those unused transportation paths are omitted in optimized network structure 500. For example, although customer 140 (corresponding to note 490) has the capability to receive products from distributing facility 130 (corresponding to node 480), an actual flow of products along this route does not provide an optimized solution. As result, optimized network structure 500 omits this path as indicated by the omission of edge 436 between nodes 480 and 490.

In another exemplary embodiment, an optimized network structure generated by system 200, although mathematically optimized, may be unduly sensitive to changes in network parameters or conditions. As a result, supply chain 100 that is configured based on such optimized network structure may not be stable or robust, and may oscillate between different states, causing inefficiency and waste. The network parameters or conditions that may cause oscillation of supply chain 100 includes, for example, demands for an item or good, such as customer demands for a product, supplier demands for a material, a part, or an item, and the like. For example, optimized network structure 500 shown in FIG. 5 may be unduly sensitive to changes in customer demands at the customers represented by node 490-494. As a result, even a small change in the customer demands may cause undesired changes in the network structure.

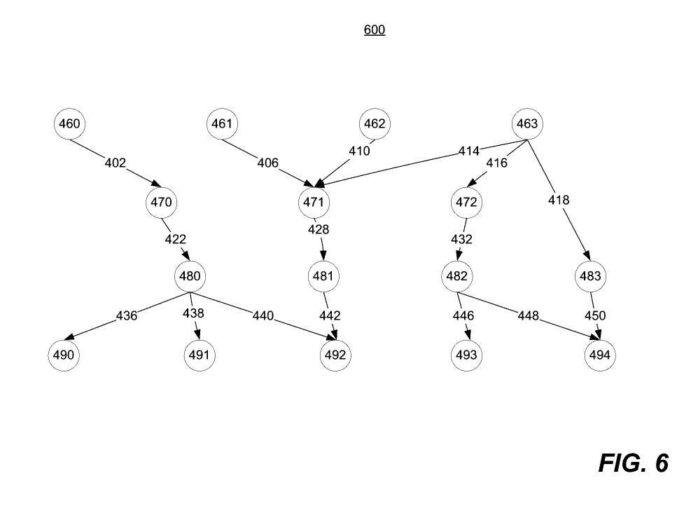

For example, according to optimized network structure 500, supply chain 100 is configured to deliver products from manufacturing facility 120 (represented by node 470) to customer 140 (represented by node 490) via a route represented by edge 420. When the customer demands increase by only a small amount, the network structure may change to a different network structure 600 shown in FIG. 6. Supply chain 100, configured according to network structure 600, changes to delivering products from distributing facility 130 (represented by node 480) to customer 140 (represented by node 490) via a path represented by edge 436. Similarly, an optimized network structure may also be sensitive to supplier demands at supplier 110-113 for a material, a part, or a component, such that when there is a slight fluctuation in the supplier demands, the supply network structure unexpectedly changes.

Such undue sensitivity to demand changes is undesired during operation of supply chain 100, because changing the transportation path generally incurs additional costs associated with, for example, moving equipment, setting up new facilities, acquiring new vehicle fleets, etc. In some instances, the optimized network structure may be so sensitive that it changes to a different structure whenever there is a fluctuation in customer demands, supplier demands, inventory levels, etc. Therefore, such a network structure is generally undesired for operation of supply chain 100, even it is optimized in the mathematical sense.

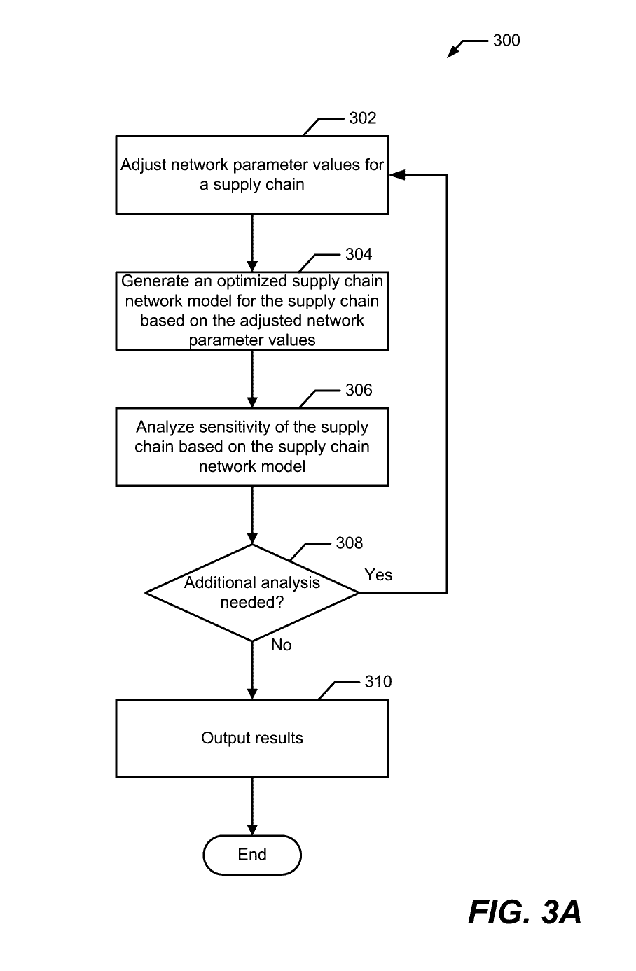

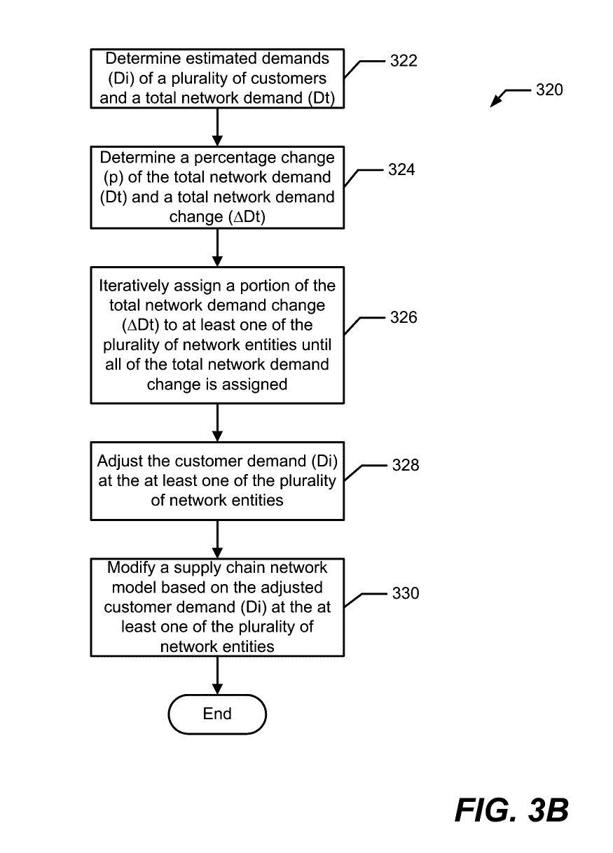

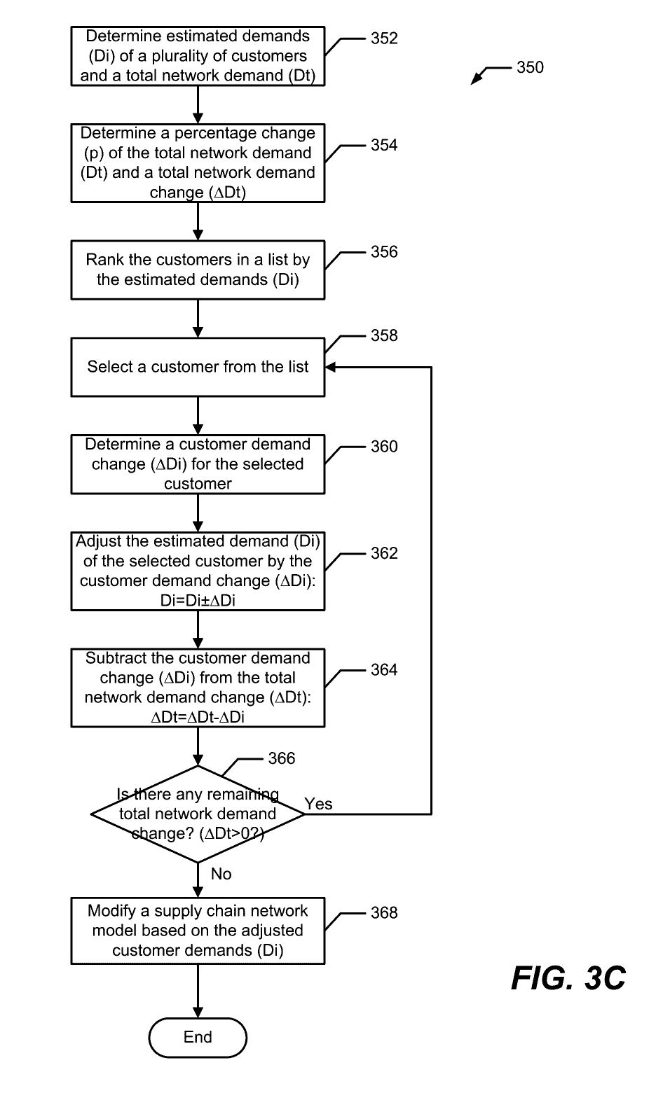

According to an exemplary embodiment, system 200 allows analysis of sensitivity of a particular optimized network structure so as discover undesirably sensitive supply chain network models. Sensitivity of a network structure for a supply chain may be analyzed by adjusting the network parameters and observing the response of the network structure. The network parameters that may be adjusted include, for example, customer demands, supplier demands, inventory levels, transportation capacities, and the like. FIG. 3A illustrates a flow chart for an exemplary process 300 that may be implemented in system 200 for supply chain sensitivity analysis, consistent with a disclosed embodiment.

According to process 300, at step 302, processor 210 may first adjust network parameter values for a supply chain. The network parameter values may indicate, for example, customer demands for a product at customers 140-144, supplier demands for a material, a part, or a component at suppliers 110-113, inventory levels at distribution facilities 130-133, capacities of the transportation paths, or demands/capacities at any other network entities.

At step 304, processor 210 generates an optimized supply chain network model for supply chain 100 based on the adjusted network parameter values. Processor 210 may use any known techniques to generate the optimized supply chain network model, such as the ant colony method, the search tree method, or other linear or nonlinear supply chain network optimization methods.

At step 306, processor 210 analyzes the sensitivity of the optimized supply chain network model. For example, processor 210 may compare the newly generated optimized supply chain network model with one or more previously generated optimized supply chain network models to determine whether there are any structural changes in the optimized network structure, such as changes in transportation routes, in response to the changes in the network parameter.

At step 308, processor 210 may determine whether additional analysis is needed. For example, if an additional adjustment of the network parameter values is needed (step 308: “Yes”), processor 210 may proceed to step 302 to adjust the network parameter values. If on the other hand, no additional adjustment is needed (step 308: “No”), processor 300 may be terminated, processor 210 may proceed to step 310 to output analysis results. Processor 210 may cause I/O device 240 to generate visual presentations to a user so that the user may view the results of the analysis. The analysis results may show or illustrate to the user how the optimized supply chain network model responds to the changes in the network parameter values. The analysis results may also provide quantification or qualification information indicating to the user whether the optimized supply chain network model is desired to implement a robust, responsive, and profitable supply chain. Based on the analysis, system 200 may determine an optimized supply chain network model that is robust and stable and transmits signals or instructions to supply chain 100 to configure supply chain 100 and the supply chain entities based on the optimized supply chain network model.

In a sensitivity analysis such as that depicted in FIG. 3A, the value of a network parameter, such as demand values or inventory levels, is usually adjusted up or down by a percentage, i.e., 1%, 5%, 10%, etc. Such adjustment is usually specified by a percentage change in a total value of the network parameter. For ease of discussion, the following exemplary embodiments use the customer demands for a product at the customers (e.g., 140-144) to illustrate the principle of the disclosure. However, one of ordinary skill in the art will appreciate that the embodiments disclosed herein may be similarly adapted to other network parameters within supply chain 100 without departure from the principle of the disclosure.

It is further assumed that the following definitions of parameters apply for conciseness and clarity:

Dt represents the total network demand (in unit) for a product at all customers;

p represents the percentage change in the total network demand for a product;

ΔDt represents the total network demand change (in unit);

Di represents the customer demand (in unit) at customer i (e.g., customer i is one of customers 140-144 in FIG. 1);

ΔDi represents the customer demand change (in unit) at customer i.

In an embodiment, based on the percentage change (p) of the total network demand (Dt), system 200 may calculate the customer demand change (ΔDi) at each customer as follows:

ΔDi=Di·p.

In addition, system 200 may adjust, up or down, the customer demand (Di) at each individual customer as follows:

Di=Di±ΔDi.

Here, the “+” symbol indicates an upward adjustment, and the “−” symbol indicates a downward adjustment.

Because a product or item cannot be sold or transported at a fractional number, the customer demands for a product must be integers. As a result, the adjusted customer demand (Di) at each individual customer must be rounded up after the adjustment, thus causing a rounding error at each individual customer. For a supply chain having a large number of customers, such rounding error for each customer demand may lead to a significant deviation from the desired percentage change (p) in the total network demand when all of the rounding errors are accumulated. For example, for a desired percentage change (p) of 1% in the total network demand, the rounding errors may result in a 2% change or even a 3% change after the rounding.

According to an exemplary embodiment, system 200 is configured to allow convenient adjustment of the total network demand (Dt) and customer demands (Di) for a supply chain network sensitivity analysis, while reducing or minimizing the rounding errors. FIG. 3B illustrates a flow chart of an exemplary process 320 for adjusting the total network demand and customer demands for supply chain network sensitivity analysis, consistent with an embodiment. Processor 320 may be implemented on system 200 shown in FIG. 2 and may be carried out during steps 302 and 304 of FIG. 3A.

According to process 320, at step 322, processor 210 determines customer demands (Di) at a plurality of customers (e.g., customers 140-144) and a total network demand (Dt) for an item. The customer demands (Di) may be determined for a particular time period, such as a day, week, month, year, etc. The customer demands (Di) for a particular time period may be determined according to known techniques based on information, such as orders received from the customers for the current time period, demand for the products in a prior time period, demand for the products in similar time periods (i.e., the same time period of prior years, months, etc.), seasonal variations, recent political events that may affect demands, and the like. Using the monthly customer demands for the month of February 2015, as an example, processor 210 may store data representing monthly customer demands in a table such as Table I shown below:

TABLE I

| | Monthly Customer Demand (Units) |
|---|---|
| D1 at Customer 140 | 3 |
| D2 at Customer 141 | 19 |
| D3 at Customer 142 | 0 |
| D4 at Customer 143 | 24 |
| D5 at Customer 144 | 8 |

The column in Table I correspond to the monthly customer demands for February 2015, while the rows in Table I corresponds to the customer demands at individual customers 140-144, respectively. The total network demand (Dt) for a particular month may be determined by summing the customer demands (D1-D5) at all of the customers for that particular month.

At step 324, processor 210 determines a percentage change (p) of the total network demand (Dt) and a total network demand change (ΔDt). The percentage change (p) may be determined based on user input, received through I/O device 240, indicating a percentage value, such as 1%, 2%, 5%, etc. The percentage change (p) may also be determined based on an automated process that increases the total network demand (Dt) by a predetermined value.

At step 326, processor 210 iteratively assigns a portion of the total network demand change (ΔDt) to at least one of the customer (e.g., 140-144) until all of the total network demand change (ΔDt) is assigned. According to an embodiment, at step 326, the customers may be ranked according to a descending order of the estimated customer demands (Di). For example, processor 210 may rank customers 140-144 in a rank list as shown in Table II below:

TABLE II

| | Monthly Customer Demand |
|---|---|
| | (Million Units) |
| D4 at Customer 143 | 24 |
| D2 at Customer 141 | 19 |
| D5 at Customer 144 | 8 |
| D1 at Customer 140 | 3 |
| D3 at Customer 142 | 0 |

Alternatively, the customers may also be ranked according to an ascending order of the estimated customer demands (Di).

After ranking the customers, processor 210 may then iteratively assign a portion of the total network demand change (ΔDt) to the customers according to the rank list (e.g., Table II). In assigning the total network demand change (ΔDt), processor 210 is configured to select at least one of the customers. In general, processor 210 selects those customers with relatively greater customer demands at earlier iterations of step 326, and selects those customers with relatively smaller customer demands at later iterations of step 326. More specifically, if there are a first customer (e.g., customer 143) with a first customer demand (e.g., D4) and a second customer (e.g., customer 141) with a second customer demand (e.g., D2), and if the first customer demand is greater than the second customer demand, process 210 is configured to select the first customer at an earlier iteration of step 326 and select the second customer at a later iteration of step 326.

In a further embodiment, process 210 may select the customer (i.e., customer 143) with the greatest customer demand at the first iteration of step 326 and sequentially select other customers (i.e., customers 141, 144, etc.) in the rank list with relatively smaller customer demands at subsequent iterations of step 326. For example, at the first iteration of step 326, processor 210 selects customer 143 from the top of the rank list. At the subsequent iterations of step 326, processor 210 selects customers 141, 144, and 140, in that order.

At each iteration of step 326, processor 210 may further determine the portion of the total customer demand change to be assigned to the selected customer. In particular, processor 210 may determine a customer demand change (ΔDi) for the selected customer according to the following formula:

ΔDi=Di·p.

For example, when customer 143 is selected at step 326, the customer demand change (ΔD4) for customer 143 is determined to be ΔD4=D4·p.

According to a further embodiment, at each iteration of step 326, processor 210 subtracts the customer demand change (ΔDi) for the selected customer from the total network demand change (ΔDt):

ΔDt=ΔDt−ΔDi.

According to a further embodiment, during step 326, processor 210 also omits those customers (e.g., 142) with customer demands equal to zero.

After assigning all of the total network demand change at step 326, processor 210 proceeds to step 328 to adjust the customer demand (Di) of the at least one customer selected at step 326 by the calculated customer demand change (ΔDi). The customer demand (Di) is adjusted as follows:

Di=Di±ΔDi.

Here, the “+” symbol indicates an upward adjustment, and the “−” symbol indicates a downward adjustment. If ΔDi is a fractional number, the adjusted customer demand (Di) is rounded up or down in the direction of scaling to the next integer.

At step 330, processor 210 modifies the supply chain network model based on the adjusted customer demand (Di) of the at least one customer obtained at step 328 above. Processor 210 may modify the supply chain network model by using the adjusted customer demand (Di) of the at least one customer to optimize the supply chain network model using any known technique. Processor 210 may further store the modified supply chain network model.

FIG. 3C illustrates a flow chart of another exemplary process 350 for adjusting the total network demand and customer demands for supply chain network sensitivity analysis, consistent with an exemplary embodiment. Similarly, process 350 may be implemented on system 200 shown in FIG. 2 and may be carried out during steps 302 and 304 of FIG. 3A.

According to process 350, at step 352, processor 210 determines customer demands (Di) of a plurality of customers (e.g., customers 140-144) and a total network demand (Dt). Processor 210 may store data representing customer demands in a table, such as Table I shown above. At step 354, processor 210 determines a percentage change (p) of the total network demand (Dt) and a total network demand change (ΔDt). At step 356, processor 210 ranks the customers in a rank list based on their respective estimated customer demands (Di). The customers may be ranked in a rank list as shown in Table II above.

Subsequent steps 358-366 form an iterative process. In particular, at step 358, processor 210 selects a customer from the rank list generated at step 356. In general, a customer with a relatively greater customer demand is selected before a customer with a relatively smaller customer demands. For example, processor 210 may select the customer with the greatest customer demand at the first iteration of the iterative process. In particular, when the customers are ranked according the ascending order of their estimated customer demands, processor 210 may select the customer from the top of the rank list starting from the first customer in the rank list. Alternatively, when the customers are ranked according to the descending order of their estimated customer demands, processor 210 may select the customer from the bottom of the rank list starting from the last customer in the rank list.

At each subsequent iteration of the iterative process, processor 210 selects the customer in the rank list who has the next greatest customer demand. Using the rank list in Table II as an example, processor 210 may select customer 143 who has the greatest customer demand D4 at the first iteration of step 358, select customer 141 who has the second greatest customer demand D2 at the second iteration of step 358, select customer 144 who has the third greatest customer demand D5 at the third iteration of step 358, etc. According to a further embodiment, processor 210 may omit those customers with customer demands equal to zero (e.g., customer 142).

At step 360, processor 210 determines a customer demand change (ΔDi) for the selected customer. ΔDi may be determined according to the following formula:

ΔDi=Di·p.

For example, when customer 143 is selected at step 358, the customer demand change for customer 143 is determined to be ΔD4=D4·p.

At step 362, processor 210 adjusts the estimated customer demand (Di) of the selected customer by the customer demand change (ΔDi) determined at step 360. The estimated customer demand (Di) is adjusted as follows:

Di=Di±ΔDi.

Here, the “+” symbol indicates an upward adjustment, and the “−” symbol indicates a downward adjustment. If ΔDi is a fractional number, the adjusted customer demand (Di) is rounded up or down in the direction of scaling to the next integer.

At step 364, processor 210 subtracts the customer demand change (ΔDi) for the selected customer from the total network demand change (ΔDt) determined at step 354:

ΔDt=ΔDt−ΔDi.

At step 366, processor 210 determines whether there is any remaining total network demand, i.e., whether ΔDt>0. If there is remaining total network demand (i.e., “Yes” at step 366), processor 210 returns to step 358 to select another customer, such as a customer with the next greatest customer demand as discussed above.

If, on the other hand, there is no remaining total network demand (i.e., “No” at step 366), processor 210 proceeds to step 368. In other words, when ΔDt0, the percentage change in the total network demand is satisfied by the adjustments to the individual customer demands. Accordingly, at step 368, processor 210 modifies the supply chain network model based on the adjusted estimated customer demands (Di). Processor 210 may modify the supply chain network model by using the adjusted customer demands (Di) to optimize the supply chain network model using any known technique. Processor 210 may further store the modified supply chain network model.

Process 350 may be carried out for multiple values of the percentage change (p). The modified supply chain network model according to each value of the percentage change (p) may be stored. Processor 210 may then use the stored supply chain network models to analyze the sensitivity of the supply chain at step 306 of FIG. 3A. For example, by comparing the supply chain network model shown in FIG. 5, and the modified supply chain network model shown in FIG. 6, processor 210 may determine that the structure of the supply chain network model of FIG. 5 changes in response to a percentage change in the total network demand (Dt). Processor 210 may compare the percentage change in the total network demand with a threshold value. If the structure of the supply chain network model changes in response to a percentage change that is below a certain threshold value, processor 210 may indicate the supply chain network model as unduly sensitive. Processor 210 may present the analysis result to a user through a user interface.

One of ordinary skill in the art will recognize that, although the above discussion uses customer demands and total network demands for a product as example, the embodiments disclosed herein may be implemented to analysis the sensitivity of the supply chain network model in response to changes in other network parameters, such as supplier demands for a part, a component, or a subsystem at the suppliers, inventory levels at the distribution facilities, capacities of the transportation paths, etc. Further, while the embodiments described here consider one uniform time period across all customers, one skilled in the art will recognize that the process described can be applied to any number of consecutive time periods and for any number of customers. For example, the values in Tables I and II may represent demands at particular month-customer pairs. In all other regards, the process is consistent with the embodiments described above.

It will be apparent to those skilled in the art that various modifications and variations can be made to the disclosed supply chain optimization system. Other embodiments will be apparent to those skilled in the art from consideration of the specification and practice of the disclosed supply chain optimization system. It is intended that the specification and examples be considered as exemplary only, with a true scope being indicated by the following claims and their equivalents.

What is claimed is:

1. A computer-implemented method for configuring, using a processor, a supply chain used to produce and deliver tangible goods based on a network sensitivity analysis, the supply chain including a plurality of network entities, the method comprising:
a) generating, by the processor, a supply chain network model for the supply chain;
b) determining, by the processor based on the supply chain network model, entity demands for an item at a plurality of network entities and a total network demand for the item;
c) determining, by the processor, a percentage change in the total network demand;
d) selecting, by the processor, one of the network entities;
e) determining, by the processor, an entity demand change for the selected network entity based on the percentage change in the total network demand and the entity demand at the selected network entity;
f) adjusting, by the processor, the entity demand at the selected network entity by the entity demand change;
g) modifying, by the processor, the supply chain network model using the adjusted entity demand at the selected network entity;
h) comparing, by the processor, the supply chain network model and the modified supply chain network model;
i) analyzing, by the processor, sensitivity of the supply chain network model based on the comparison; and
j) configuring the supply chain according to the sensitivity analysis of the supply chain network model.

2. The method of claim 1, further comprising:
determining a total network demand change based on the total network demand and the percentage change in the total network demand;
reducing the total network demand change by the entity demand change; and
determining whether the reduced total network demand change is greater than zero.

3. The method of claim 2, further comprising performing steps d)-f) iteratively until the reduced total network demand change is equal to zero.

4. The method of claim 1, wherein selecting one of the network entities further comprises ranking the network entities in a rank list based on the entity demands of the network entities.

5. The method of claim 1, wherein the entity demand of the selected network entity is greater than the entity demand of at least one other non-selected network entity.

6. The method of claim 5, wherein the selected network entity has the greatest entity demand among the plurality of network entities.

7. The method of claim 3, wherein the plurality of network entities includes a first network entity having a first network demand for the item and a second network entity having a second network demand for the item, and
the method further comprises:
selecting the first network entity at a relatively earlier iteration of step d); and
selecting the second network entity at a relatively later iteration of step d).

8. The method of claim 1, further comprising:
determining a difference between the supply chain network model and the modified supply chain network model based on the comparison;
analyzing the sensitivity of the supply chain network model based on the difference; and
determining whether to implement the supply chain network model on the supply chain based on the analysis.

9. The method of claim 8, further comprising presenting the difference to a user.

10. The method of claim 1, further comprising:
determining whether the entity demand of at least one of the plurality of network entities is equal to zero; and
omitting any network entities having a zero entity demand.

11. A computer-implemented method for configuring, using a processor, a supply chain used to produce and deliver tangible goods based on a network sensitivity analysis, the supply chain including a plurality of network entities, the method comprising:
generating, by the processor, a supply chain network model for the supply chain;
determining, by the processor based on the supply chain network model, entity demands for an item at the plurality of network entities and a total network demand for the item;
determining, by the processor, a total network demand change based on a percentage change in the total network demand;
iteratively assigning, by the processor, a portion of the total network demand change to at least one of the plurality of network entities until all of the total network demand change is assigned;
adjusting, by the processor, the entity demand at the at least one of the plurality of network entities by the assigned portion of the total network demand change;
modifying, by the processor, the supply chain network model using the adjusted entity demand at the at least one of the plurality of network entities;
analyzing, by the processor, sensitivity of the supply chain network model based on the modified supply chain network model; and
configuring the supply chain according to the sensitivity analysis of the supply chain network model.

12. The method of claim 11, further comprising ranking the plurality of network entities in a rank list based on the entity demands at the plurality of network entities.

13. The method of claim 11, wherein the iteratively assigning a portion of the total network demand change further comprises performing the following steps iteratively until all of the total network demand change is assigned:
a) selecting one of the plurality of network entities;
b) determining an entity demand change for the selected network entity based on the entity demand at the selected network entity and the percentage change in total network demand;
c) adjusting the entity demand of the selected network entity by the entity demand change; and
d) reducing the total network demand change by the entity demand change.

14. The method of claim 13, wherein the entity demand at the selected network entity is greater than the entity demand of at least one other non-selected network entity.

15. The method of claim 13, wherein, at the first iteration of the iteratively assigning step, the selected network entity has the greatest entity demand among the plurality of network entities.

16. The method of claim 13, wherein the plurality of network entities includes a first network entity having a first entity demand for the item and a second network entity having a second entity demand for the item, the first entity demand is greater than the second entity demand, and
the method further comprises:
selecting the first network entity at a relatively earlier iteration; and
selecting the second network entity at a relatively later iteration.

17. The method of claim 13, further comprising omitting a network entity if the network entity has an entity demand equal to zero.

18. A system for configuring a supply chain used to produce and deliver tangible goods based on a network sensitivity analysis, the supply chain including a plurality of network entities, the system comprising:
a memory configured to store instructions;
one or more input/output devices configured to receive user inputs and generate a user interface; and
a processor configured to receive the instructions from the memory and execute the instructions, the instructions causing the processor to:
generate a supply chain network model for the supply chain;
determine, based on the supply chain network model, entity demands for an item at the plurality of network entities and a total network demand for the item;
determine a total network demand change based on a percentage change in the total network demand;
iteratively assign a portion of the total network demand change to at least one of the plurality of network entities until all of the total network demand change is assigned;
adjust the entity demand at the at least one of the plurality of network entities by the assigned portion of the total network demand change;
modify the supply chain network model using the adjusted entity demand at the at least one of the plurality of network entities;
analyze sensitivity of the supply chain network model based on the modified supply chain network model; and
configure the supply chain according to the sensitivity analysis of the supply chain network model.

19. The system of claim 18, wherein the instructions further cause the processor to receive, through the input device, a user input representing the percentage change in the total network demand.

20. A non-transitory computer-readable medium including instructions, which, when executed by a processor, cause the processor to perform a method for configuring a supply chain used to produce and deliver tangible goods based on a network sensitivity analysis, the supply chain including a plurality of network entities, the method comprising:
generating a supply chain network model for the supply chain;
determining, based on the supply chain network model, entity demands for an item at the plurality of network entities and a total network demand for the item;
determining a total network demand change based on a percentage change in the total network demand;
iteratively assigning a portion of the total network demand change to at least one of the plurality of network entities until all of the total network demand change is assigned;
adjusting the entity demand at the at least one of the plurality of network entities by the assigned portion of the total network demand change;
modifying the supply chain network model using the adjusted entity demand at the at least one of the plurality of network entities;
analyzing sensitivity of the supply chain network model based on the modified supply chain network model; and
configuring the supply chain according to the sensitivity analysis of the supply chain network model.
